(19) United States
(12) Patent Application Publication
(10) Pub. No.: US 2025/0303295 A1
(43) Pub. Date: Oct. 2, 2025

(54) METHOD FOR USING AI TO CUSTOMIZE IN GAME AUDIO

(71) Applicant: Sony Interactive Entertainment LLC, San Mateo, CA (US)

(72) Inventors: Karthick Manivannan, San Mateo, CA (US); Sankar THIAGASAMUDRAM, San Mateo, CA (US)

(21) Appl. No.: 18/623,930

(22) Filed: Apr. 1, 2024

(51) Int. Cl. A63F 13/54; A63F 13/215

(52) U.S. Cl. CPC A63F 13/54; A63F 13/215

(57) ABSTRACT

Techniques are described for customizing computer game audio using artificial intelligence (AI). Game audio is sent to a pre-trained machine learning (ML) model to identify designate audio objects such as voices, footsteps, and gunshots, enhance the audio objects by amplifying them and/or shifting frequency and/or clarifying them, and insert the enhanced objects back into the game audio in real time.

### FIELD

The present application relates to technically inventive, non-routine solutions that are necessarily rooted in computer technology and that produce concrete technical improvements, and more specifically to using artificial intelligence to customize computer game audio.

### BACKGROUND

Computer games may be played on a variety of platforms, including home video game consoles, PCs, and cloud servers emulating consoles or PCs. As understood herein, gamers may which to enhance certain audio objects. For example, a gamer may wish to gain an advantage in a stealthy game by better hearing footsteps of an adversary. Or, a person experiencing difficulty hearing voices in lower registers may wish to be able to hear those voices better.

### SUMMARY

As understood herein, enhancing game audio simply using EQ or other straightforward signal manipulation that amplifies a particular frequency band causes all audio objects in that frequency band to be amplified, not just a single audio object that may be of particular interest to the gamer.

Accordingly, an apparatus includes at least one processor assembly configured to receive at least one signal from at least one microphone during presentation of a computer game. The processor assembly is configured to input the signal to at least one machine learning (ML) model, and receive from the ML model at least one predicted audio object. The processor assembly also is configured to alter the predicted audio object received from ML model to render an altered audio object and replace an audio object from the computer game that the signal represents with the altered audio object such that at least one speaker plays the altered audio object in lieu of the audio object from the computer game that the signal represents.

In examples, the altered audio object has a greater amplitude than the audio object from the computer game that the signal represents, and/or a different frequency than the audio object from the computer game that the signal represents, and/or greater acoustic clarity than the audio object from the computer game that the signal represents.

If desired, the processor assembly may be configured to receive from the ML model, in response to input of the signal, the predicted audio object and no other audio objects.

Without limitation, the altered audio object may include a footstep object, a weapon noise object, or a voice.

In example implementations the signal from the microphone represents only an initial portion of the audio object from the computer game that the signal represents.

In another aspect, a method includes sending microphone signals to at least one machine learning (ML) model during presentation of at least one computer simulation. The method includes receiving, in response to the sending, a predicted audio object, and enhancing the predicted audio object received from the ML model to render an enhanced audio object. The method also includes playing, on at least one speaker, audio from the computer simulation using the enhanced audio object.

In another aspect, a device includes at least one computer storage that is not a transitory signal and that in turn includes instructions executable by at least one processor assembly for receiving audio from a computer game during game play, and sending the audio to at least one machine learning (ML) model. The instructions are executable to using output of the ML model to render an altered audio object, and playing the altered audio object during game play instead of an audio object in the audio from the computer game.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example consistent with present principles;

FIG. 2 illustrates an example game system consistent with present principles;

FIG. 3 illustrates and example game system architecture consistent with present principles;

FIG. 4 illustrates example logic in example flow chart format for training a machine learning (ML) model consistent with present principles;

FIG. 5 illustrates example overall logic in example flow chart format;

FIG. 6 illustrates example logic in example flow chart format for a first audio object enhancement technique;

FIG. 7 illustrates example logic in example flow chart format for a second audio object enhancement technique;

FIG. 8 illustrates example logic in example flow chart format for a third audio object enhancement technique;

FIG. 9 illustrates an example user interface for selecting a desired audio object to be enhanced; and

FIG. 10 illustrates an example user interface for selecting a desired audio object enhancement.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor assembly may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

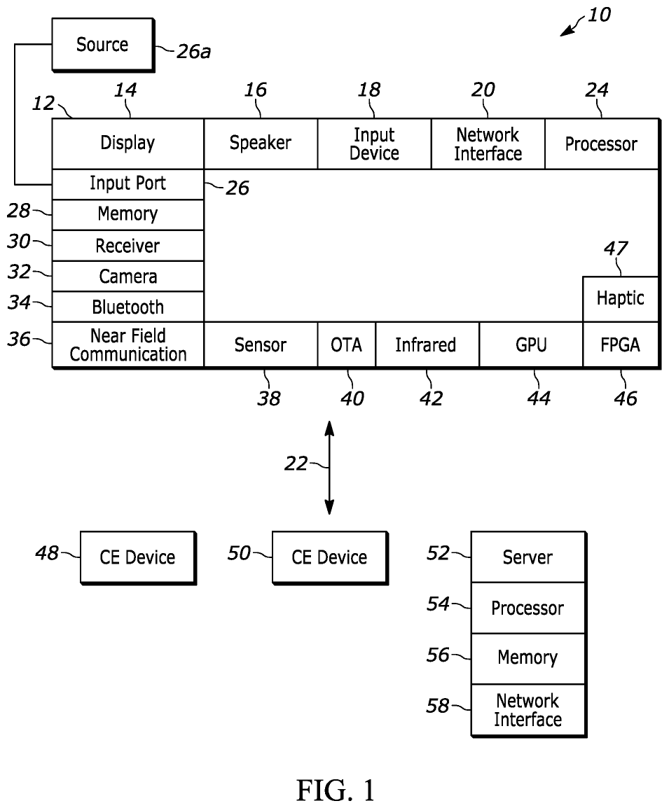

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console such as a Sony PlayStation® or Microsoft Xbox® may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) or headphones worn by a player. When embodied as a HMD, the second CE device 50 may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Large language models (LLM) such as generative pre-trained transformers (GPTT) and stable diffusion (SD) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

The system of FIG. 1 and following figures enhances audio for gaming using a neural network (NN) (which may be implemented in a machine learning (ML) model) using preexisting data. Then the neural weights are used for isolating certain sounds (like footsteps) and enhancing them. In non-limiting embodiments chipsets may be used that have generic neural network accelerators built in, and pre-trained data (e.g., footsteps in a game) can be loaded into the NN accelerators to enhance game objects.

Accordingly, present principles are directed to use Artificial Intelligence (AI) and Machine Learning (ML) to customize and/or enhance in-game audio. Present techniques identify specific audio objects such as, but not limited to, footsteps, gunshots, and voices within a game's audio track and adjusting their prominence to either provide a competitive advantage to players or assist individuals with hearing impairments. The versatility of present techniques extends to various applications, including but not limited to enhancing game immersion, improving accessibility, and personalizing the gaming experience according to player preferences or needs.

As set forth further below, present techniques use AI-powered game audio element(s)/object(s) extraction in which AI training is used to accurately identify and isolate specific sound elements from a complex game audio mix without manual input. Dynamic audio enhancement is then implemented in which real-time adjustment is made of specific audio elements' volume and clarity, such as amplifying footsteps in a stealth game to provide tactical advantages. Customization options are provided in which players customize which audio elements are enhanced, allowing for a personalized gaming experience. Accessibility features are also facilitated by tailoring audio enhancements to assist players with hearing disabilities, making games more inclusive and accessible. This targeted approach, especially in real-time, sets it apart from general audio processing technologies.

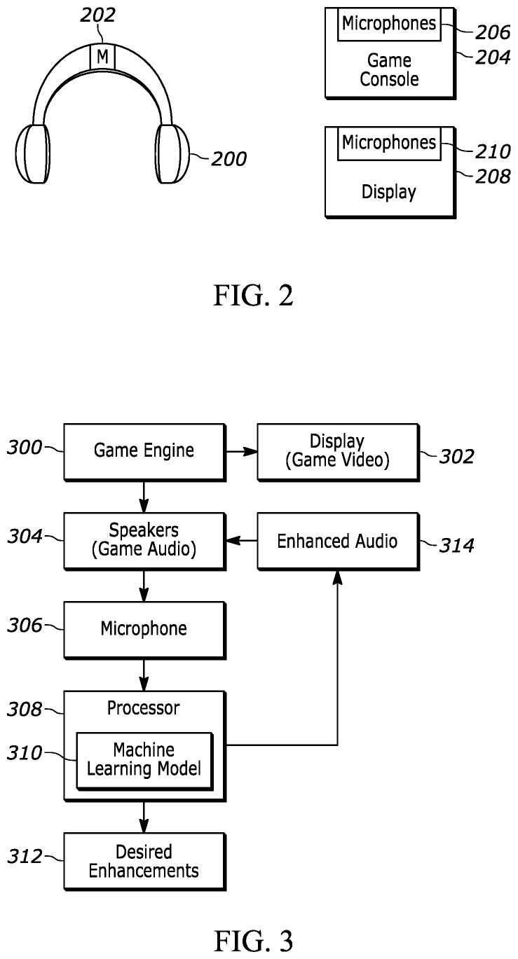

FIG. 2 illustrates a speaker device 200 configured as audio headphones for playing audio during execution of a computer simulation, such as during play of a computer game. In some examples, one or more microphones 202 may be provided on the device 200 to pick up simulation audio and send signals indicative thereof to the AI/ML components described herein, which may be executed by a processor assembly in the device 200. Also, a game console 204 with one or more optional microphones 206 may source a computer game for presentation on one or more displays 208, which also may optionally have one or more microphones 210. Any of the microphones described herein may provide signals representing game audio to the AI/ML components described herein to execute present techniques. Thus, both the pick up microphone and processor implementing the AI/ML techniques may be in the headphone speaker device 200 and/or game console 204 and/or display 208.

FIG. 3 illustrates further details of an architecture that may be used by any of the components in FIG. 2. A computer simulation source such as a computer game engine 300 may send game video to a display 302 for presentation of the video during game play. The game engine 300 also may send audio to one or more speakers 304 such as headphone speakers to play game audio during game play. The game audio played on the speakers 304 may be picked up by one or more microphones 306 and provided to one or more processor assemblies 308 executing one or more ML models 310. Based on input of the microphone signals the ML model 310 outputs predicted audio objects that can be enhanced as described further below according to desired enhancements 312 to establish enhanced audio objects 314, which are then played on the speakers 304 in lieu of the original audio objects.

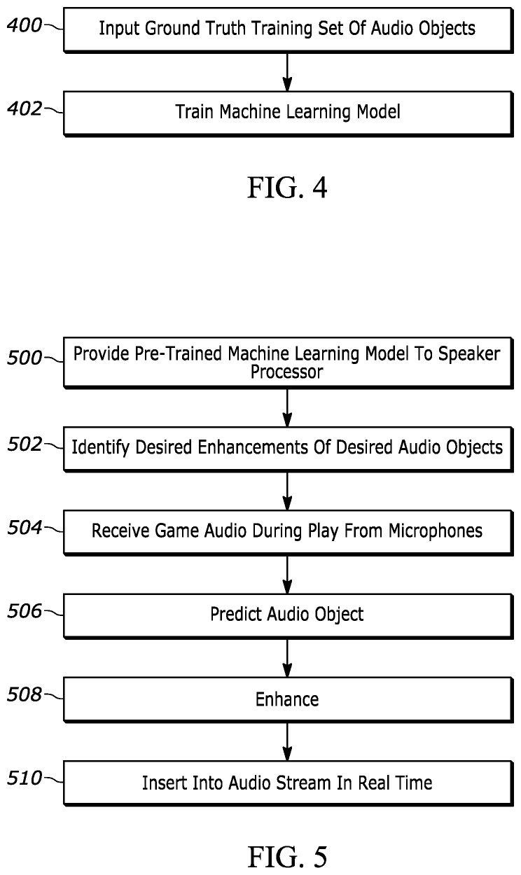

FIG. 4 illustrates that the ML model 310 may be pre-trained prior to game play by inputting, at state 400, microphone signals with ground truth indication of what audio objects the signals represent. Note that the ground truth microphone signals may represent only the initial part of an audio object, so that the ML model can be trained at state 402 to predict an audio object using only the first segment of a waveform the audio object causes a microphone to produce. In this way, audio objects being played during game play can be predicted by the pre-trained AI/ML, enhanced, and inserted back into the audio in lieu of the original audio object in sufficiently real time so as to be effectively imperceptible to a gamer listening to the game audio.

Refer now to FIG. 5. At state 500 the pre-trained ML model described above is provided to a processor assembly such as a speaker processor assembly such as may be found in a chipset in a headphone device or other speaker device. Moving to state 502, desired audio object enhancements are identified. Examples of these desired enhancements are discussed further below, and can include indications from a developer or an end user of specific audio objects types to be enhanced (such as footstep audio objects, gunshot audio objects, and voice audio objects) as well as, if desired, specific forms of enhancement.

Moving to state 504, signals are received from one or more microphones such as the microphone 202 shown in FIG. 2 during computer simulation play such as computer game play. The signals from the microphone(s) represent audio from the simulation as played on one or more speakers, such as the speakers of the headphone 200. State 506 indicates that the signals are provided to the ML model which outputs a prediction of a specific audio represented in the signals based on the identification of desired audio objects to detect/predict at state 502. Enhancements are applied at state 508 to the predicted audio object according to desired enhancements from state 502, and at state 510 the enhanced audio object is inserted into the audio stream of the computer simulation to be played in lieu of the complete original audio object in real time.

Thus, the technique of FIG. 5 identifies and trains a suitable ML model and uses the trained model for real-time analysis of the game's audio feed to identify distinct sounds including but not limited to footsteps and gunshots. Once identified, these sounds are processed according to the user's settings, which can involve amplification, clarity enhancement, or other modifications. The processed audio is then seamlessly integrated back into the game's audio output, ensuring the enhancements feel natural and integrated into the game's environment. Note that the logic of FIG. 5 and other logic herein may be implemented in software or in hardware such as a GPU to reduce latency.

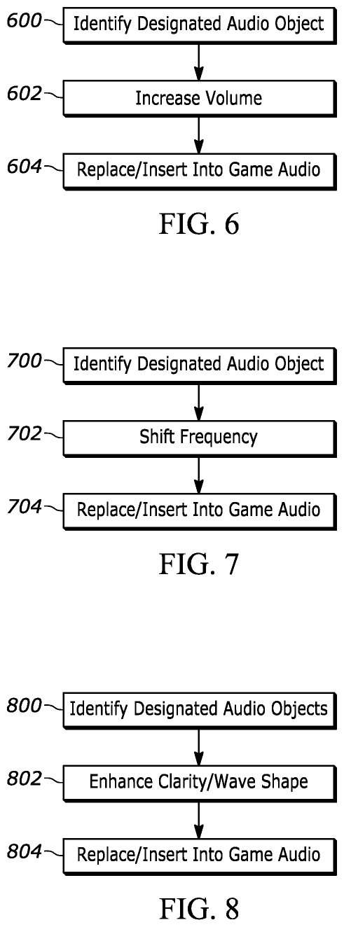

FIGS. 6-8 illustrate techniques for enhancing a predicted audio object output by the ML model. Commencing at state 600 in FIG. 6, one or more audio objects are received from the ML model consistent with disclosure above. Proceeding to state 602, the volume (signal amplitude) of the predicted audio object is increased with respect to a volume of the audio object to be replaced that was originally in the audio stream. The enhanced predicted audio object is then inserted into the audio stream of the game in real time during game play at state 604 to replace the original audio object (i.e., replace the portion of the original audio object that has not yet been played, which in most cases is most of the original audio object).

Commencing at state 700 in FIG. 7, one or more audio objects are received from the ML model consistent with disclosure above. Proceeding to state 702, the frequency/frequency band of the predicted audio object is shifted to a different frequency/band than that of the audio object from the computer game that the microphone signal represents. For example, the frequency of a predicted voice audio object may be shifted to a higher register than the register of the original voice object to aid a person who may have difficulty hearing lower-pitched voices. The enhanced predicted audio object is then inserted into the audio stream of the game in real time during game play at state 704 to replace the original audio object (i.e., replace the portion of the original audio object that has not yet been played, which in most cases is most of the original audio object).

Commencing at state 800 in FIG. 8, one or more audio objects are received from the ML model consistent with disclosure above. Proceeding to state 802, the acoustic clarity of the predicted audio object is made clearer than that of the audio object from the computer game that the signal represents. This may involve smoothing the waveform of the predicted audio object compared to the waveform of the original audio object, for example. The enhanced predicted audio object is then inserted into the audio stream of the game in real time during game play at state 804 to replace the original audio object (i.e., replace the portion of the original audio object that has not yet been played, which in most cases is most of the original audio object).

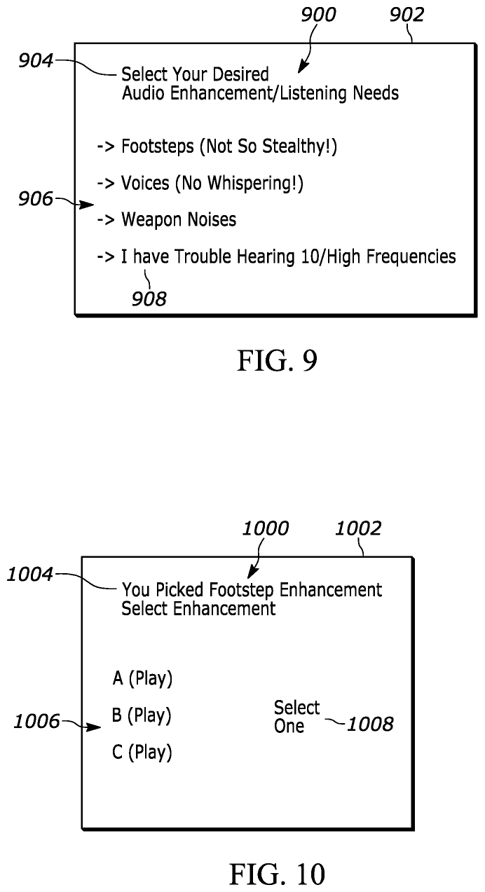

FIG. 9 illustrates a user interface (UI) 900 that may be presented visibly and/or audibly and/or tactilely to select one or more desired audio objects to be enhanced. In the example shown, the UI 900 is presented visibly on a display 902. The UI 900 may include a prompt 904 to select a desired audio object to be enhanced and/or to select a listening requirement that can be correlated to an audio enhancement.

In the example shown, the UI 900 includes a list 906 of audio objects from which a user can select one or more audio objects to be enhanced. The example list 906 includes footstep audio objects that, for example, can be amplified to give the player an advantage in a stealth computer game. The example list 906 may include voice audio objects to again give advantage to a player in being able to hear whispered voices in a stealth game and/or to aid a person who may have difficulty hearing voices in computer games. Also, the example list 906 may include weapon noise audio object such as gunshot audio objects.

Further, as shown at 908 in FIG. 9, the list 906 may include one or more descriptions of hearing needs, in the example shown, that the user has difficulty in hearing audio objects in the lower frequencies of the human hearing range or audio objects in the higher frequencies of the human hearing range, for shifting the frequencies of predicted audio objects away from the frequencies of the corresponding original audio objects accordingly.

FIG. 10 illustrates a UI 1000 that may be presented visibly and/or audibly and/or tactilely to select one or more desired audio objects to be enhanced. In the example shown, the UI 1000 is presented visibly on a display 1002. The UI 1000 may include a prompt 1004 to select a specific enhancement for an audio object such as one selected using the UI 900 of FIG. 9.

As shown in FIG. 10, a list 1006 of candidate enhancements may be presented, in the example shown, candidate enhancements A-C, along with a prompt 1008 to select one of the candidate enhancements. The candidate enhancements may be pre-programmed enhancements from the developer based on enhancements that have been determined to be effective or popular, for instance. Each candidate enhancement may be implemented on the selected audio object and/or a test tone and when clicked on, played on a speaker so that the user can select each individual candidate enhancement in sequence and listen to each individually to subjectively determine for himself which candidate he prefers. For instance, candidate enhancements may include their own respective volumes and/or frequency ranges. The user then indicates selection of one of the candidate enhancements to implement during game play at block 508 in FIG. 5. It is to be understood that the example of FIG. 10 is not limiting and that other techniques to establish enhancement of audio objects may be employed.

Imaging of game video also may be used to identify audio objects to be enhanced to reduce latency.

While particular techniques are herein shown and described in detail, it is to be understood that the subject matter which is encompassed by the present application is limited only by the claims.

What is claimed is:

1. An apparatus comprising:
at least one processor assembly configured to:
receive at least one signal from at least one microphone during presentation of a computer game;
input the signal to at least one machine learning (ML) model;
receive from the ML model at least one predicted audio object;
alter the predicted audio object received from ML model to render an altered audio object; and
replace an audio object from the computer game that the signal represents with the altered audio object such that at least one speaker plays the altered audio object in lieu of the audio object from the computer game that the signal represents.

2. The apparatus of claim 1, wherein the altered audio object has a greater amplitude than the audio object from the computer game that the signal represents.

3. The apparatus of claim 1, wherein the altered audio object has a different frequency than the audio object from the computer game that the signal represents.

4. The apparatus of claim 1, wherein the altered audio object has greater acoustic clarity than the audio object from the computer game that the signal represents.

5. The apparatus of claim 1, wherein the processor assembly is configured to receive from the ML model, in response to input of the signal, the predicted audio object and no other audio objects.

6. The apparatus of claim 1, wherein the altered audio object comprises a footstep object.

7. The apparatus of claim 1, wherein the altered audio object comprises a weapon noise object.

8. The apparatus of claim 1, wherein the altered audio object comprises a voice.

9. The apparatus of claim 1, wherein the signal represents only an initial portion of the audio object from the computer game that the signal represents.

10. A method, comprising:
sending microphone signals to at least one machine learning (ML) model during presentation of at least one computer simulation;
receiving, in response to the sending, a predicted audio object;
enhancing the predicted audio object received from the ML model to render an enhanced audio object; and
playing, on at least one speaker, audio from the computer simulation using the enhanced audio object.

11. The method of claim 10, comprising:
playing the audio from the computer simulation using the enhanced audio object in lieu of an audio object that caused the microphone to generate to generate the microphone signals.

12. The method of claim 10, comprising:
generating the enhanced audio object at least in part by increasing an amplitude relative to an amplitude of an audio object represented by the microphone signals.

13. The method of claim 10, comprising:
generating the enhanced audio object at least in part by changing a frequency relative to a frequency of an audio object represented by the microphone signals.

14. The method of claim 10, comprising:
generating the enhanced audio object at least in part by increasing clarity relative to clarity of an audio object represented by the microphone signals.

15. The method of claim 10, comprising:
presenting at least one user interface configured to receive input indicating a desired enhancement to implement on an audio object.

16. The method of claim 10, comprising:
presenting at least one user interface configured to receive input indicating a desired audio object to enhance.

17. A device comprising:
at least one computer storage that is not a transitory signal and that comprises instructions executable by at least one processor assembly for:
receiving audio from a computer game during game play;
sending the audio to at least one machine learning (ML) model;
using output of the ML model to render an altered audio object; and
playing the altered audio object during game play instead of an audio object in the audio from the computer game.

18. The device of claim 17, wherein the instructions are executable for:
presenting at least one user interface configured to receive input indicating a desired enhancement to implement on an audio object; and
generating the altered audio object based at least in part on the input.

19. The device of claim 17, wherein the instructions are executable for:
presenting at least one user interface configured to receive input indicating a desired audio object to enhance; and
rendering the altered audio object based at least in part on the input.

20. The device of claim 17, wherein the instructions are executable for:
rendering the altered audio object using audio from the computer game representing only an initial portion of an audio object.
